(19) United States
(12) Patent Application Publication
(10) Pub. No.: US 2003/0084312 A1
(43) Pub. Date: May 1, 2003

(54) Method for compulsorily using original interface card

(76) Inventor: Wen Chi Lin, Taipei Hsien (TW)

Correspondence Address: Wen Chi Lin, P.O. Box 10-69, Chong Ho, Taipei, 235, TW

(21) Appl. No.: 09/984,103

(22) Filed: Oct. 29, 2001

(51) Int. Cl. H04L 9/00

(52) U.S. Cl. 713/193

(57) ABSTRACT

A method is used for preventing the users to use the interface card without the permission of the original supplier. A RAM and a memory are stored in the interface card and coupled with each other. A portion of an AP code and an STA code are stored in the memory and load into the RAM. Another portion of the AP code is stored in a member and loaded into the RAM for covering the STA code and for forming a complete AP code. The RAM of the interface card may be permitted to use only when or after the portions of the AP codes are matched with each other.

### BACKGROUND OF THE INVENTION

1. Field of the Invention

The present invention relates to a method and more particularly to a method for forcing the users to use the interface cards provided by the original suppliers and for preventing the users to copy and to use the interface cards without the permission of the original suppliers.

2. Description of the Prior Art

Various kinds of typical interface cards have been developed and provided for engaging into the computer facilities or devices or the like, and for allowing the users to enter into the computer facilities and for allowing the local area network (LAN) to be coupled or connected to the wireless local area network (WLAN) or the like, with the routers, the modems the asymmetric digital subscriber line (ADSL), or the like. However, once the user purchase one set of the interface cards and/or the working platforms or the like, the other computer facilities and/or the other unauthorized persons may also easily use the interface cards and/or the working platforms or the like, by such as a simple copying process, or the like, without purchasing the other interface cards and/or the working platforms or the like; i.e., the users need not to purchase the interface cards provided by the original suppliers and may copy and use the interface cards without the permission of the original suppliers. The interface cards and/or the working platforms or the like may thus be unsalable, and the designers and/or the manufacturers and/or the suppliers are no longer willing to design and to manufacture and to supply the further interface cards and/or the working platforms or the like. This is not fair to the designers and/or the manufacturers and/or the suppliers of the interface cards and/or the working platforms or the like.

The present invention has arisen to mitigate and/or obviate the afore-described disadvantages of the conventional interface cards.

### SUMMARY OF THE INVENTION

The primary objective of the present invention is to provide a method for forcing the users to use the interface cards provided by the original suppliers and for preventing the users to copy and to use the interface cards without the permission of the original suppliers.

In accordance with one aspect of the invention, there is provided a method for forcing users to use an interface card provided by an original supplier and for preventing the users to use the interface card without the permission of the original supplier, the method comprises providing a RAM in the interface card, providing a memory, storing a first AP code in the memory, loading the first AP code from the memory to the RAM, providing a member, storing a second AP code in the member, loading the second AP code from the member to the RAM, and determining whether the first AP code matches with the second AP code or not.

A STA code is further provided and stored in the memory, and is loaded from the memory to the LAM. The second AP code may be covered onto the STA code in the RAM to form a complete AP code. The first AP code includes a first half of the complete AP code, and the second AP code includes a second half of the complete AP code.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram of a working platform having an interface card in accordance with the present invention;

FIGS. 2, 3 are block diagrams illustrating the method for using the interface cards that are provided by the original suppliers; and

FIG. 4 is a flow chart illustrating the reasoning of the method for forcing the users to use the interface cards provided by the original suppliers and for preventing the users to copy and to use the interface cards without the permission of the original suppliers.

### DETAILED DESCRIPTION OF THE PREFERRED EMBODIMENT

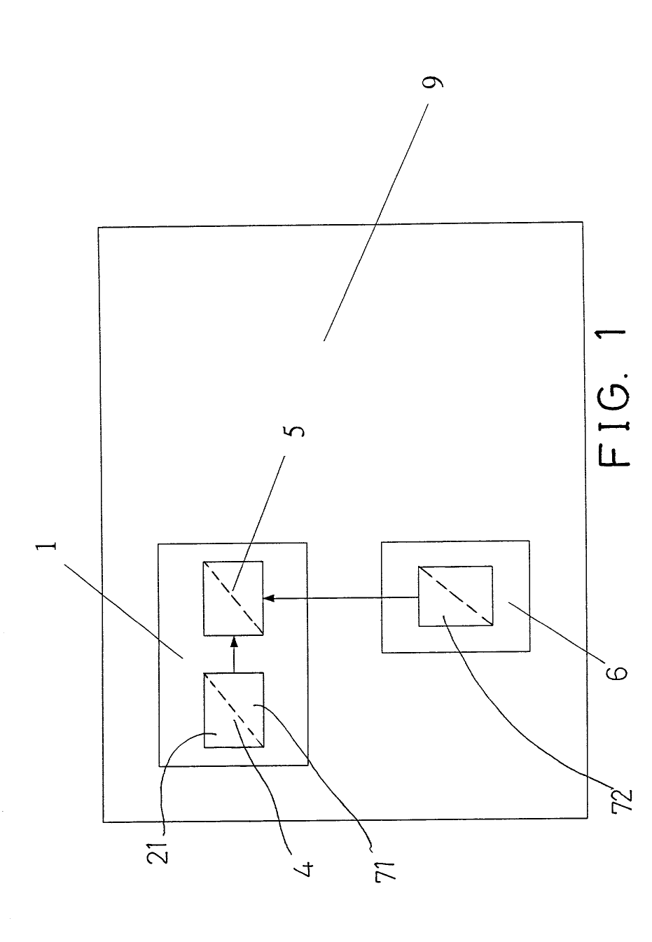

Referring to the drawings, and initially to FIG. 1, a method in accordance with the present invention is provided for forcing the users to use the interface cards 1 provided by the original suppliers and for preventing the users to copy or to use the interface cards 1 without the permission of the original suppliers. The interface card 1 is required to be plugged or engaged into the computer facilities 9 or the computer devices or the like, and for allowing the users to enter into the computer facilities 9 and for allowing the users to couple local area network (LAN) to the wireless local area network (WLIN) or the like, with the coupling members, or hardware members 6, such as the routers, the modems, the asymmetric digital subscriber line (ADSL), or the like.

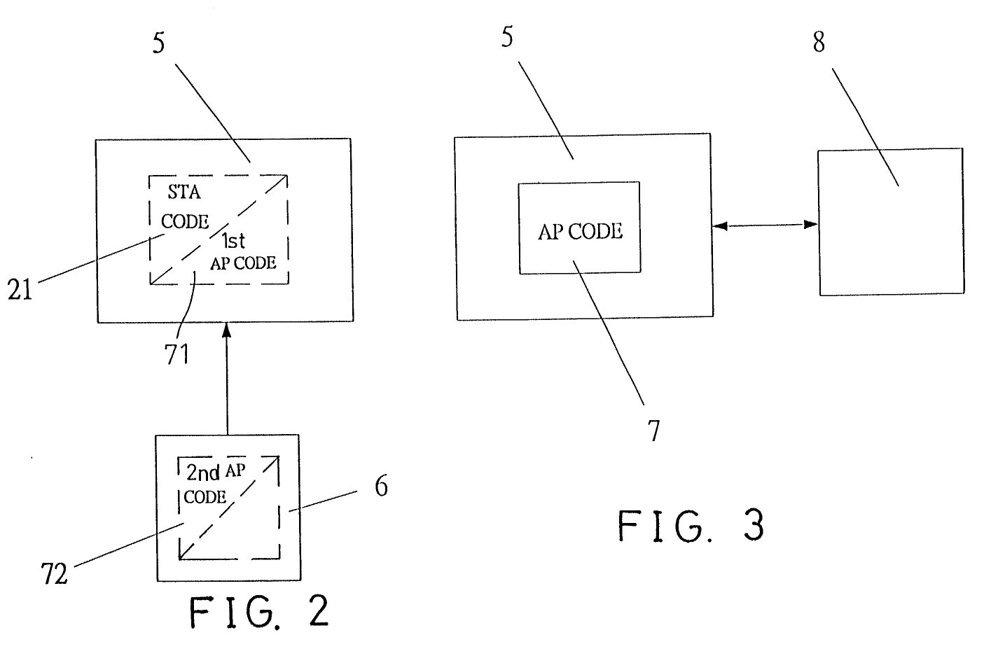

Referring next to FIG. 2 and again to FIG. 1, the interface card 1 includes a random access memory (RAM) 5, and a flash memory 4 coupled to the random access memory (RAM) 5. The computer facility 9 includes a hardware member 6 coupled to the random access memory (RAM) 5 of the interface card 1. The flash memory 4 includes a portion, such as one half (½) of the size or the area or the volume or the like having a station (STA) code 21 recorded or stored or built therein, and includes the other portion such as the other half (½) of the size or the area or the volume or the like having a first access point (AP) code 71 recorded or stored or built therein. The STA code 21 and the first AP code 71 of the flash memory 4 may be copied or loaded to the RAM 5 when or after the computer facility 9 and/or the interface card 1 has been actuated or has been energized.

The hardware member 6 of the computer facility 9 includes a portion, such as one half (½) of the size or the area or the volume or the like having a second access point (AP) code 72 recorded or stored or built therein. The second access point (AP) code 72 recorded in the hardware member 6 of the computer facility 9 may be selectively obtained or down loaded into the RAM 5 and may cover the STA code 21 to form a complete AP code 7 as shown in FIG. 3. When the second access point (AP) code 72 of the RAM 5 that is down loaded from the hardware member 6 of the computer facility 9 is matched or is determined to be matched with the first access point (AP) code 71 of the RAM 5 that is down loaded or copied or transferred from the flash memory 4, the complete AP code 7 (FIG. 3) may thus be formed and may be used for permitting or for allowing the RAM 5 to couple or to connect to the other computer facilities, or the other local area networks, or the other wireless local area networks 8, or the like.

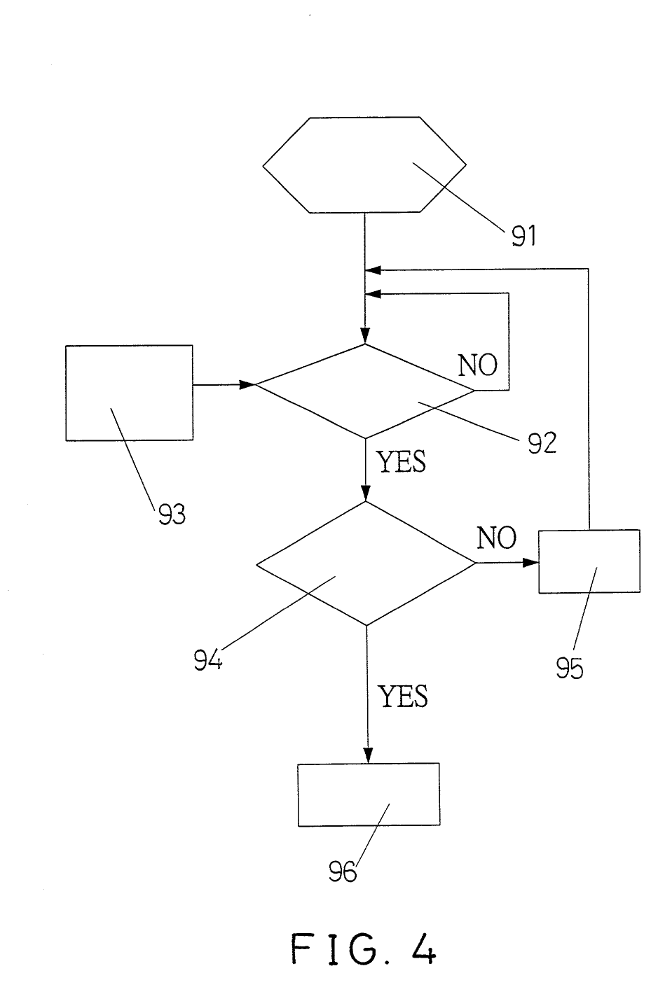

In operation, as shown in FIG. 4, the STA code 21 and the first AP code 71 are first recorded or stored or built into the flash memory 4 at process 91. The STA code 21 and the first AP code 71 of the flash memory 4 may then be copied or loaded to the RAM 5 at process 92. If not, it will wait until the STA code 21 and the first AP code 71 have been loaded to the RAM 5. The second AP code 72 recorded in the hardware member 6 of the computer facility 9 will then be selectively down loaded into the RAM 5 at process 93 and to cover the STA code 21 in the RAM 5. The first AP code 71 and the second AP code 72 will then be compared or determined whether they are matched with each other or not at the process 94. If the first AP code 71 and the second AP code 72 are not matched with each other or are not the required codes, a fail signal will be issued at process 95 and will then return to the process 92 for allowing the other or the correct codes to be loaded into the RAM 5. If the first AP code 71 and the second AP code 72 are matched with each other or are determined to be the required codes, a complete or a correct AP code 7 may be formed in process 96 and may allow or permit the interface card 1 to be used or coupled to the other computer facilities, or the other local area networks, or the other wireless local area networks 8, or the like.

Accordingly, the method in accordance with the present invention may be used for forcing the users to use the interface cards provided by the original suppliers and for preventing the users to copy and to use the interface cards without the permission of the original suppliers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for forcing users to use an interface card provided by an original supplier and for preventing the users to use the interface card without the permission of the original supplier, said method comprising:
providing a RAM in the interface card,
providing a memory,
storing a first AP code in said memory,
loading said first AP code from said memory to said RAM,
providing a member,
storing a second AP code in said member,
loading said second AP code from said member to said RAM, and
determining whether said first AP code matches with said second AP code or not.

2. The method according to claim 1 further comprising storing a STA code in said memory, and loading said STA code from said memory to said RAM.

3. The method according to claim 2 further comprising covering said second AP code onto said STA code in said RAM to form a complete AP code.

4. The method according to claim 3, wherein said first AP code includes a first half of said complete AP code, and said second AP code includes a second half of said complete AP code.
